(19) United States
(12) Patent Application Publication
(10) Pub. No.: US 2011/0270985 A1
(43) Pub. Date: Nov. 3, 2011

(54) METHOD OF AUTOMATICALLY IDENTIFYING MULTISERVICE AND METHOD OF PROVIDING MULTISERVICE USING THE SAME

(75) Inventors: Nam Kyoung UM, Cheongju-si (KR); Tae Whan Yoo, Daejeon (KR); Ho Young Song, Daejeon (KR); Tae Yeon Kim, Daejeon (KR); Dongguk Je, Daejeon (KR); Seung Hyun Yoon, Daejeon (KR); Jeong-Hun Shin, Daejeon (KR)

(73) Assignee: Electronics and Telecommunications Research Institute, Daejeon (KR)

(21) Appl. No.: 12/962,684

(22) Filed: Dec. 8, 2010

(30) Foreign Application Priority Data
Apr. 29, 2010 (KR) 10-2010-0040155

(51) Int. Cl. G06F 15/173

(52) U.S. Cl. 709/225

(57) ABSTRACT

An open access node receives a dynamic IP address corresponding to a terminal that requests a connection from a specific server, and provides the dynamic IP address to the terminal. Next, the open access node receives a service that is requested by a user from the terminal that is connected using the dynamic IP address, and stores a MAC address of the terminal and a service in a database. When the terminal again requests a connection, the open access node identifies a service that is requested by a user of the terminal based on the MAC address of the terminal.

### CROSS-REFERENCE TO RELATED APPLICATION

This application claims priority to and the benefit of Korean Patent Application No. 10-201 0-00401 55 filed in the Korean Intellectual Property Office on Apr. 29, 2010, the entire contents of which are incorporated herein by reference.

### BACKGROUND OF THE INVENTION

(a) Field of the Invention

The present invention relates to a method of automatically identifying a multiservice and a method of providing a multiservice using the same. Particularly, the present invention relates to a method of automatically identifying a multiservice and a method of providing a multiservice using the same in an environment in which a plurality of service providers exist.

(b) Description of the Related Art

As communication network environments gradually change to a communication network service based on Internet protocol (hereinafter referred to as “IP”), various services such as Internet protocol television (hereinafter referred to as “IPTV”) and voice over Internet protocol (hereinafter referred to as “VoIP”) as well as a wideband Internet service are advanced to a triple play service (hereinafter referred to as “TPS”)/quad play service (hereinafter referred to as “QPS”) that is provided through one line.

However, in the Republic of Korea, an Internet service, an IPTV, and a VoIP service are provided to a residence by a communication provider. Therefore, in order to receive various services, the service user should select several services that are provided by one communication provider rather than to select various communication providers.

Such environmental restrictions may generate the following problems.

First, a service user's service options may be limited. For example, in order to use an Internet service of a first provider and an IPTV service of a second communication provider, networks of two providers should be provided to a residence and thus a free option of users is deteriorated and a combined service of the first provider's Internet service and the second provider's IPTV service should be selected. That is, a service option that is provided by a service provider rather than a service option that a service user prefers is selected.

Second, a complicated line that is provided by a plurality of providers may be a restriction in realizing green IT. For example, in the present domestic communication network environment, when the first provider and the second provider provide a network equipment to a residence in an apartment, the service user can select both a first service of the first provider and a second service of the second provider. This has a problem that an operation cost to an equipment investment cost (OPEX/COPEX) due to overlapped equipment increases and that uses excessive energy.

Third, the competitive power of late providers may be weakened due to an excessive entry barrier. That is, communication providers having a backbone network and an access network raise the quality of service (QoS) of an Internet service, an IPTV service, and a VoIP service thereof and lowers the QoS of other providers. Resultantly, competitive power of late communication providers may be weakened, and service quality that is provided to the service user may be gradually deteriorated.

In order to improve a problem of such communication environment, an open access network performs a function of a portion corresponding to a lead-in network in a large scale of an apartment complex.

In such an environment, the service provider sets a session to the open access network and registers a service list through the open access node. Further, the service user connects to the open access network and selects and registers a service that the service user wants, and the service user sets a desired condition and uses the service.

In this case, when a service user that has been connected to a service tries to connect again to the service after termination of a session, the service user should again select a provider and request a connection.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of automatically identifying a multiservice and a method of providing a multiservice using the same having advantages of automatically identifying a service user's service when the service user tries to connect again to a service after termination of a session, and connecting a service corresponding to a plurality of providers.

An exemplary embodiment of the present invention provides a method for an open access nod to automatically identify a multiservice desired by a terminal, the method comprising:

receiving a dynamic IP address corresponding to a terminal that requests a connection from a server and providing the dynamic IP address to the terminal; receiving information on a service that a user requests from the terminal connected using the dynamic IP address; storing at least one identification element corresponding to the terminal to be matched with the information on the desired service in a database; and identifying the service requested by the user of the terminal based on the at least one identification element, when the terminal requests again a connection.

Another embodiment of the present invention provides a method for an open access node to provide a multiservice to a terminal when the terminal is again connected after providing of a specific service to the terminal has been terminated, the method comprising:

performing an authentication procedure of the terminal that requests a service is again requested and a user of the terminal; searching for whether connection information exists within a database; receiving a dynamic IP address corresponding to the connection information, if the connection information exists; providing the dynamic IP address to the terminal and inquiring of the terminal whether to again receive the specific service; and providing the specific service to the terminal according to the inquiry result.

### BRIEF DESCRIPTION OF THE DRAWINGS

FIG. 1 is a diagram illustrating a communication environment according to an exemplary embodiment of the present invention.

FIG. 2 is a diagram illustrating a method of automatically identifying a multiservice according to a first exemplary embodiment of the present invention.

FIG. 3 is a diagram illustrating a table within a database according to a first exemplary embodiment of the present invention.

FIG. 4 is a diagram illustrating a method of automatically identifying a multiservice according to a second exemplary embodiment of the present invention.

FIG. 5 is a diagram illustrating a table within a database according to a second embodiment of the present invention.

FIG. 6 is a diagram illustrating a method of automatically identifying a multiservice according to a third exemplary embodiment of the present invention.

FIG. 7 is a diagram illustrating a table within a database according to a third exemplary embodiment of the present invention.

FIG. 8 is a diagram illustrating a method of automatically identifying a multiservice according to a fourth exemplary embodiment of the present invention.

FIG. 9 is a diagram illustrating a table within a database according to a fourth exemplary embodiment of the present invention.

FIG. 10 is a diagram illustrating a DPI engine for being applied to a method of automatically identifying a multiservice according to a fourth exemplary embodiment of the present invention.

FIG. 11 is a diagram illustrating a method in which a service user receives a multiservice according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification, unless explicitly described to the contrary, the word “comprise” and variations such as “comprises” or “comprising” will be understood to imply the inclusion of stated elements but not the exclusion of any other elements.

In this specification, a terminal may indicate a mobile station (MS), a mobile terminal (MT), a subscriber station (SS), a portable subscriber station (PSS), user equipment (UE), and an access terminal (AT), and may include an entire function or a partial function of the MS, the MT, the SS, the PSS, the UE, and the AT.

In this specification, a base station (BS) may indicate an access point (AP), a radio access station (RAS), a node-B, an evolved node-B (eNB), a base transceiver station (BTS), and a mobile multihop relay (MMR)-BS, and may include an entire function or a partial function of the AP, the RAS, the node-B, the eNB, the BTS, and the MMR-BS.

Hereinafter, a method of automatically identifying a multiservice according to an exemplary embodiment of the present invention and a method of providing a multiservice using the method will be described in detail with reference to the drawings.

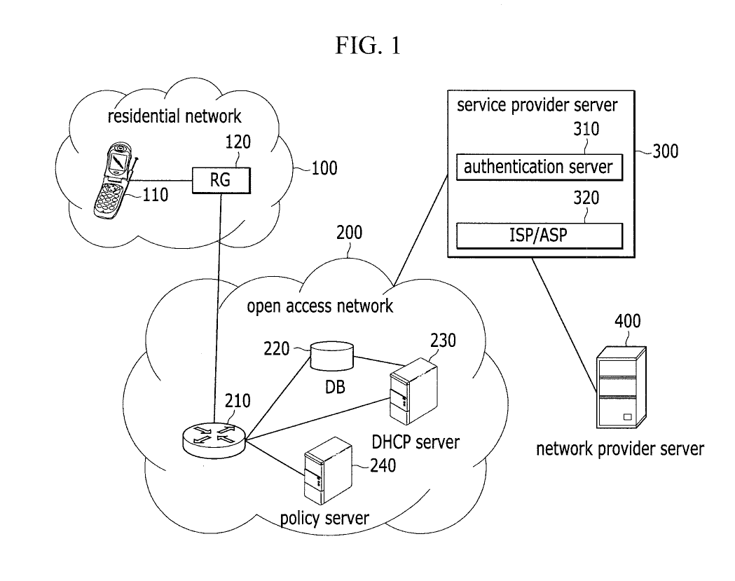

FIG. 1 is a diagram illustrating a communication environment according to an exemplary embodiment of the present invention.

As shown in FIG. 1, communication environment according to an exemplary embodiment of the present invention includes a residential network 100, an open access network 200, a service provider server 300, and a network provider server 400.

In such communication environment, the open access network 200 connects the residential network 100 and the service provider server 300, and transfers a service of the service provider server 300 to a service user that is connected to the residential network 100.

That is, a terminal 110 of the service user is positioned at the residential network 100. Here, the terminal 110 of the service user includes a computer, a television, and a mobile phone of a customer premises network (CPN). In this case, the terminal 110 is directly connected to an open access node or is connected to an open access node through a distributor, which is positioned at a common segment such as an MDF or a communication room that is positioned at a lead-in segment of a subscriber through a residential gateway (hereinafter referred to as “RG”) 120, a modem, or a set-top box that is connected to the terminal 110.

The open access network 200 includes an open access node 210, a database (DB) 220, a dynahost configuration protocol (DHCP) server 230, and a policy server 240.

The service provider server 300 includes an authentication server 310 and an Internet service provider (hereinafter referred to as “ISP”)/application service provider (hereinafter referred to as “ASP”) 320.

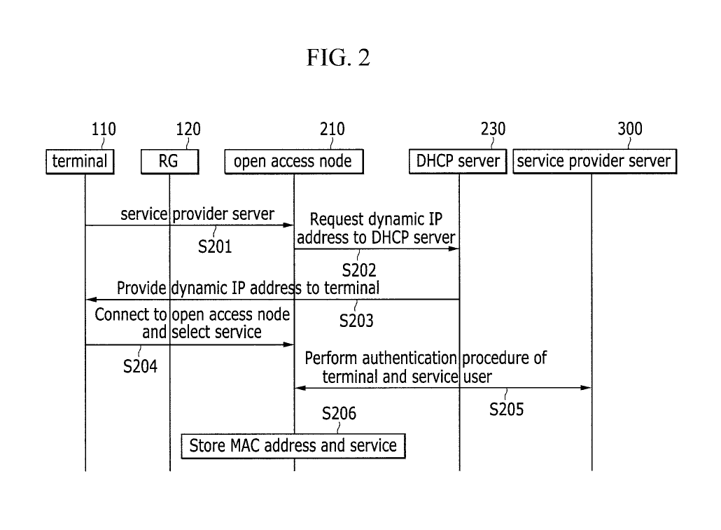

A method of automatically identifying a multiservice corresponding to each service user in such communication environment will be described in detail with reference to FIGS. 2 to 9.

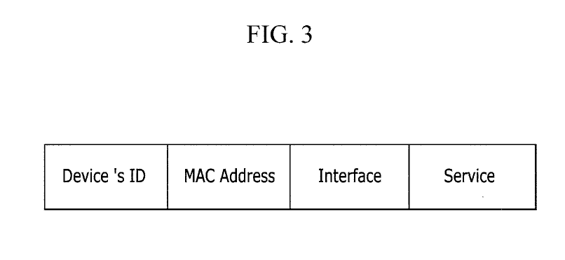

FIG. 2 is a diagram illustrating a method of automatically identifying a multiservice according to a first exemplary embodiment of the present invention, and FIG. 3 is a diagram illustrating a table within a DB according to a first exemplary embodiment of the present invention.

First, a method of automatically identifying a multiservice according to a first exemplary embodiment of the present invention can support a MAC layer (layer 2), and is not limited thereto.

As shown in FIG. 2, the terminal 110 is connected to the open access node 210 through the RG 120 (S201).

The open access node 210 requests a dynamic IP address corresponding to the terminal 110 from the DHCP server 230 (S202).

The DHCP server 230 temporarily allocates a dynamic IP address and provides the dynamic IP address to the terminal 110 via the open access node 210 (S203).

The terminal 110 connects again to the open access node 210 using the dynamic IP address and selects a desired service kind (S204). In this way, when the terminal 110 connects again to the open access node 210, the terminal 110 transmits a service list that is requested by a service user, a MAC address, and service user information to the open access node 210.

The open access node 210 requests authentication of a terminal to connect and a corresponding service user from a corresponding service provider server 300, and performs an authentication procedure (S205). In this case, the service provider server 300 corresponds to a service kind that is selected by the service user.

The open access node 210 stores a MAC address of a terminal that is connected to the open access node 210 and a service that is requested by the service user in the DB 220 (S206).

That is, the open access node 210 according to a first exemplary embodiment of the present invention stores a MAC address of the connected terminal 110 and a service that is requested by the service user in the DB 220, and thus when the terminal 110 again requests a connection, the open access node 210 can identify the service that is requested by the service user using the MAC address of the terminal 110. As shown in FIG. 3, a table within the DB 220 includes ID of a device that is connected to the open access node 210, a MAC address of the terminal 110, an interface, and a service that is requested by the service user.

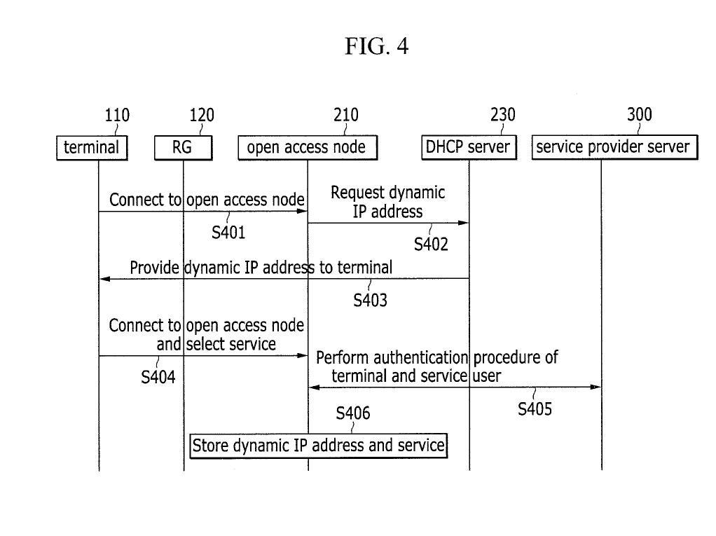

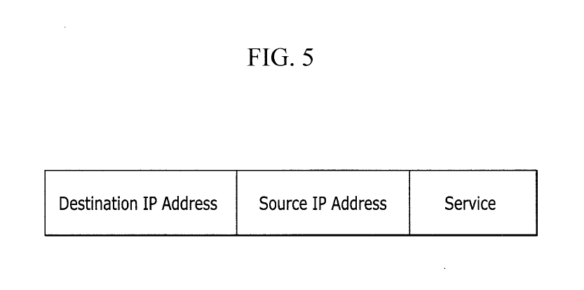

FIG. 4 is a diagram illustrating a method of automatically identifying a multiservice according to a second exemplary embodiment of the present invention, and FIG. 5 is a diagram illustrating a table within a DB according to a second embodiment of the present invention.

First, the method of automatically identifying a multiservice according to the second exemplary embodiment of the present invention can support an IP layer (layer 2), and is not limited thereto.

As shown in FIG. 4, the terminal 110 is connected to the open access node 210 through the RG 120 (S401).

The open access node 210 requests a dynamic IP address corresponding to the terminal 110 that is connected to the open access node 210 from the DHCP server 230 (S402).

The DHCP server 230 differently allocates an allocation range of the dynamic IP address on a service basis, unlike the first exemplary embodiment, and provides the dynamic IP address to the terminal 110 via the open access node 210 (S403).

The terminal 110 connects again to the open access node 210 using the dynamic IP address and selects a desired service kind (S404). In this way, when the terminal 110 connects again to the open access node 210, the terminal 110 transmits a service list that is requested by the service user, a MAC address, and service user information to the open access node 210.

The open access node 210 requests authentication of the terminal 110 to connect and a corresponding service user from a corresponding service provider server 300, and performs an authentication procedure (S405). In this case, the service provider server 300 corresponds to a service kind that is selected by the service user.

The open access node 210 stores a dynamic IP address of the terminal 110 that is connected to the open access node 210 and a service that is requested by the service user in the DB 220 (S406).

The open access node 210 according to the second exemplary embodiment of the present invention stores a dynamic IP address of the connected terminal 110 and a service that is requested by the service user in the DB 220, and thus when the terminal 110 again requests a connection, the open access node 210 can identify a service that is requested by the service user using the dynamic IP address and the service.

As shown in FIG. 5, a table within the DB 220 includes a destination IP address, a source IP address, and a service that is requested by the service user.

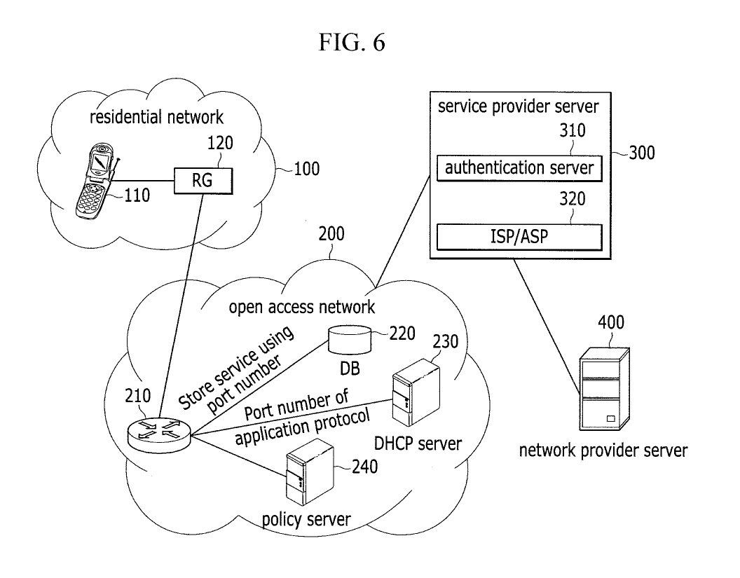

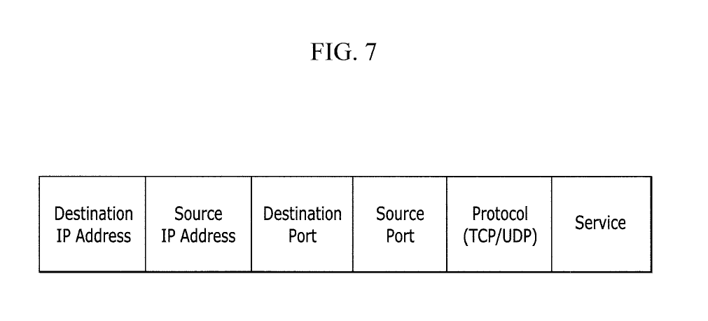

FIG. 6 is a diagram illustrating a method of automatically identifying a multiservice according to a third exemplary embodiment of the present invention, and FIG. 7 is a diagram illustrating a table within a DB according to the third exemplary embodiment of the present invention.

First, the method of automatically identifying a multiservice according to the third exemplary embodiment of the present invention is similar to the method of automatically identifying a multiservice according to the second exemplary embodiment.

However, an open access node 210 according to the third exemplary embodiment of the present invention searches for protocol header information of an application layer (layer 7), recognizes a port number of an application protocol, and stores the port number in a DB 220. As shown in FIG. 7, a table within the DB 220 includes a destination IP address, a source IP address, a destination port, a source port, a protocol (TCP/UDP), and a service that is requested by a service user.

When the terminal 110 again requests a connection, the open access node 210 according to the third exemplary embodiment of the present invention can identify a service that is requested by a service user using a port number of the application protocol as well as a dynamic IP address.

For example, in order to use a hyper-text transport protocol (HTTP) service for an Internet web service, a port number such as 80/TCP and 80/UDP is used. Further, a session initiation protocol (SIP) that provides a session connection for VoIP uses a port number such as 5060/TCP and 5060/UDP, and the H.323 protocol uses an intrinsic port number such as 2517/TCP and 2517/UDP and thus services can be classified on an application protocol basis.

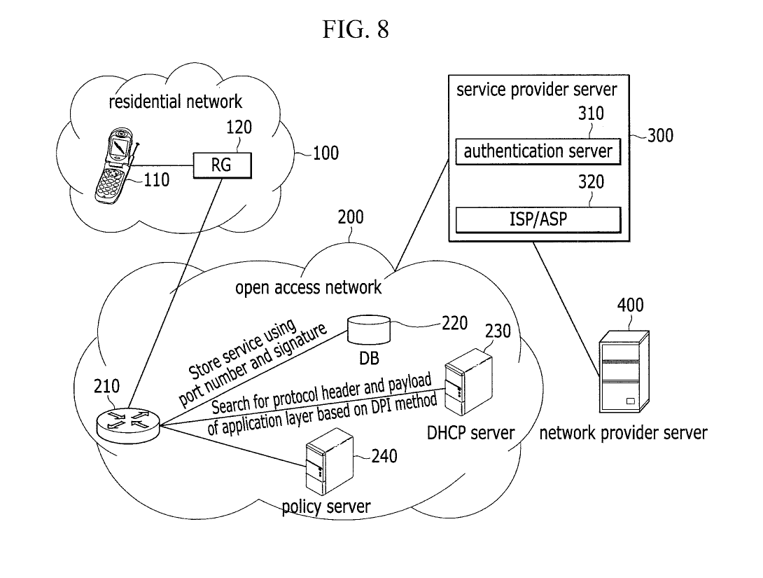

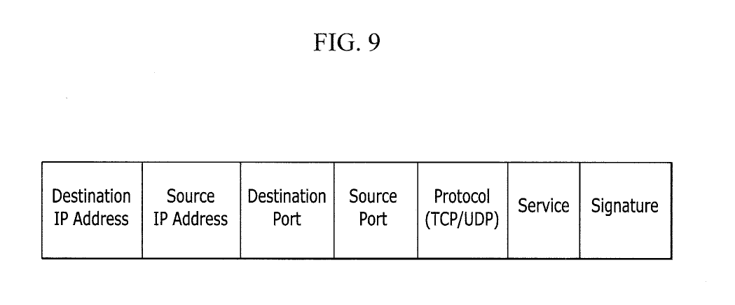

FIG. 8 is a diagram illustrating a method of automatically identifying a multiservice according to a fourth exemplary embodiment of the present invention, and FIG. 9 is a diagram illustrating a table within a DB according to the fourth exemplary embodiment of the present invention.

First, the method of automatically identifying a multiservice according to the fourth exemplary embodiment of the present invention is similar to the method of automatically identifying a multiservice according to the third exemplary embodiment.

An open access node 210 according to the fourth exemplary embodiment of the present invention searches for a protocol header and a payload of an application layer (layer 7) based on a deep packet inspection (hereinafter referred to as “DPI”) method. Next, the open access node 210 can sustain a previous connection state based on a determination result of a signature, i.e., cookie information, within the payload. Further, when cookie information is false information, the open access node 210 can limit use of the cookie information.

The open access node 210 according to the fourth exemplary embodiment of the present invention stores a dynamic IP address, a service that is requested by a service user, a port number of an application protocol, and a signature at the DB 220. As shown in FIG. 9, a table within the DB 220 includes a destination IP address, a source IP address, a destination port, a source port, a protocol (TCP/UDP), a service that is requested by a service user, and a signature.

Further, when the terminal 110 again requests a connection, the open access node 210 according to the fourth exemplary embodiment of the present invention can identify a service that is requested by a service user using a port number of an application protocol and a signature, as well as a dynamic IP address.

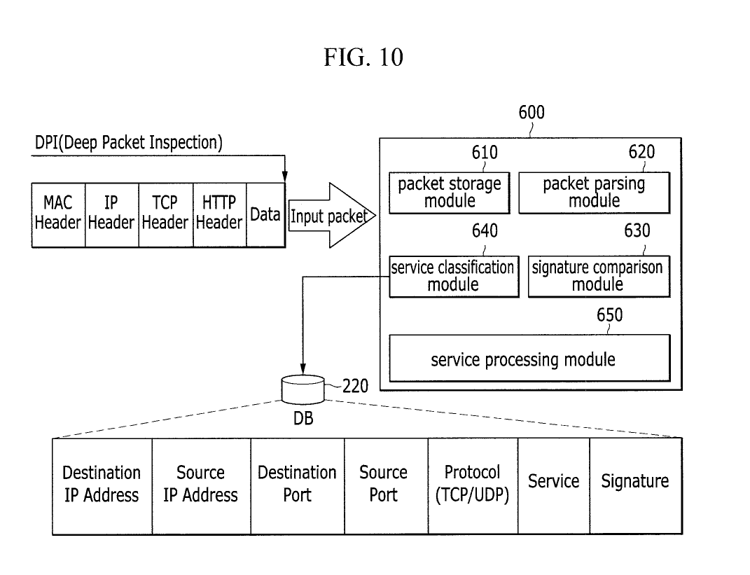

Next, a DPI engine module that identifies and classifies a multiservice using signature information will be described in detail with reference to FIG. 10.

FIG. 10 is a diagram illustrating a DPI engine for being applied to a method of automatically identifying a multiservice according to the fourth exemplary embodiment of the present invention.

As shown in FIG. 10, a DPI engine 600 includes a packet storage module 610, a packet parsing module 620, a signature comparison module 630, a service classification module 640, and a service processing module 650.

The packet storage module 610 receives and stores a DPI packet. In this case, the packet storage module 610 includes a protocol header and a payload of an application layer.

The packet parsing module 620 classifies packets that are stored in the packet storage module 610 into a header portion such as MAC/IP/TCP/HTTP and a data portion of a payload.

The signature comparison module 630 searches for a signature on a service basis in the DB 220 according to a service that is classified by a port from the data portion.

The service classification module 640 detects information such as a source IP address, a destination IP address, a source port, a destination port, and a transmission protocol from the header portion, classifies services that are found by the signature comparison module 630, and stores the services in the DB 220.

The service processing module 650 requests processing from a service engine corresponding to a service.

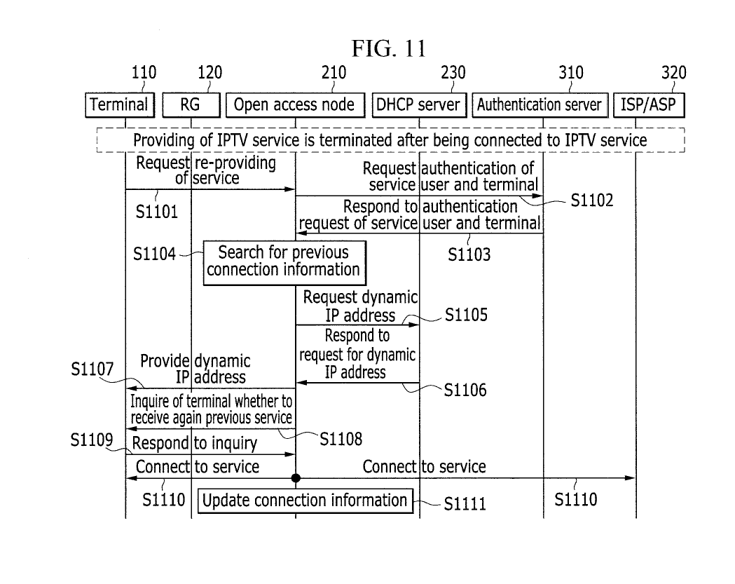

Next, a method of receiving a multiservice when connecting again to a service based on a method of automatically identifying a multiservice according to the first to fourth exemplary embodiments of the present invention will be described in detail with reference to FIG. 11.

FIG. 11 is a diagram illustrating a method in which a service user receives a multiservice according to an exemplary embodiment of the present invention.

First, the service user according to an exemplary embodiment of the present invention is in a state in which providing an IPTV service is terminated while receiving the IPTV service using the terminal 110. Further, a method in which the service user receives a multiservice by connecting again to the service through the terminal 110 uses a method of automatically identifying a multiservice according to the first to fourth exemplary embodiments.

As shown in FIG. 11, in an exemplary embodiment of the present invention, a communication environment in which the service user receives a multiservice includes the terminal 110, the RG 120, the open access node 210, the DHCP server 230, the authentication server 310, and an ISP/ASP 320.

The terminal 110 requests re-providing of a service that has previously been provided to the open access node 210 (S1101). The open access node 210 requests authentication of the terminal 110 that again requests a service and the corresponding service user from the authentication server 310 (S1102), and receives a response to the request (S1103).

The open access node 210 that completes an authentication procedure of the service user and the terminal 110 searches for previous connection information within the DB 220 (S1104). In this case, the open access node 210 can also detect supportable layer information, and information that the open access node 210 can detect is not limited thereto.

Specifically, the open access node 210 according to the first exemplary embodiment of the present invention uses a MAC address as connection information, and the open access node 210 according to the second exemplary embodiment uses a dynamic IP address as connection information. Further, the open access node 210 according to the third and fourth exemplary embodiments uses a dynamic IP address and a port number of an application protocol as connection information.

When connection information exists, the open access node 210 requests a dynamic IP address corresponding to connection information (S1105) and receives a dynamic IP address corresponding to the request (S1106).

The open access node 210 provides the received dynamic IP address to the terminal 110 (S1107). Further, the open access node 210 inquires of the terminal 110 whether to again receive a previous service (S1108), and receives a response to the inquiry from the terminal 110 (S1109).

The open access node 210 again provides a service to the service user who is connected again to the service by connecting the terminal 110 and the ISP/ASP 320 (S1110). Further, the open access node 210 stores newly updated information within the DB 220 (S1111).

Thereby, in an open access network environment according to an exemplary embodiment of the present invention, even if a service user does not again request a service that the service user has previously used, when the service user receives an inquiry from an open access node and responds to the inquiry, the service user can continuously receive a previous service without again requesting the service.

The foregoing exemplary embodiments of the present invention are not only embodied through an apparatus and a method, but are also embodied through a program that realizes a function corresponding to a configuration of an exemplary embodiment of the present invention or a recording medium on which the program is recorded, and can be easily embodied by a person of ordinary skill in the art from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for an open access nod to automatically identify a multiservice desired by a terminal, the method comprising:
receiving a dynamic IP address corresponding to a terminal that requests a connection from a server and providing the dynamic IP address to the terminal;
receiving information on a service that a user requests from the terminal connected using the dynamic IP address;
storing at least one identification element corresponding to the terminal to be matched with the information on the desired service in a database; and
identifying the service requested by the user of the terminal based on the at least one identification element, when the terminal requests again a connection.

2. The method of claim 1, wherein when the at least one identification element is a MAC address of the terminal, the identifying of a service comprises identifying the service requested by the user of the terminal based on the MAC address of the terminal.

3. The method of claim 2, wherein the database includes a table that comprises an ID of terminal that is connected to the open access node, a MAC address of the terminal, an interface, and a service that is requested by a user of the terminal.

4. The method of claim 1, further comprising performing an authentication procedure by requesting authentication of the terminal and the user of the terminal from a service provider server.

5. The method of claim 1, wherein when the at least one identification element is the dynamic IP address, the identifying of a service comprises identifying a service that is requested by the user of the terminal based on the dynamic IP address.

6. The method of claim 5, wherein the receiving of a dynamic IP address comprises receiving the dynamic IP address in different allocation ranges on a service basis.

7. The method of claim 5, wherein the database includes a table that comprises a destination IP address, a source IP address, and a service that is requested by a user of the terminal.

8. The method of claim 1, wherein the storing of at least one identification element comprises:
recognizing a port number of a protocol corresponding to an application layer of the terminal as the at least one identification element; and
matching the port number of the protocol with the service and storing them in the database.

9. The method of claim 8, wherein the identifying of a service comprises identifying a service that is requested by the user of the terminal based on the port number.

10. The method of claim 8, wherein the database includes a table that comprises a destination IP address, a source IP address, a destination port, a source port, a protocol, and a service.

11. The method of claim 1, wherein the storing of at least one identification element comprises:
searching for a protocol header and a payload corresponding to an application layer of the terminal; and
matching a port number of the protocol and a signature corresponding to the payload that are obtained from the result of the searching with the service and storing them in the database.

12. The method of claim 11, wherein the identifying of a service comprises identifying a service that is requested by the user of the terminal based on the port number and the signature.

13. The method of claim 11, wherein the database includes a table that comprises a destination IP address, a source IP address, a destination port, a source port, a protocol, a signature, and a service requested by a user.

14. A method for an open access node to provide a multiservice to a terminal when the terminal is again connected after providing of a specific service to the terminal has been terminated, the method comprising:
performing an authentication procedure of the terminal that requests a service is again requested and a user of the terminal;
searching for whether connection information exists within a database;
receiving a dynamic IP address corresponding to the connection information, if the connection information exists;
providing the dynamic IP address to the terminal and inquiring of the terminal whether to again receive the specific service; and
providing the specific service to the terminal according to the inquiry result.

15. The method of claim 14, wherein the connection information comprises a MAC address of the terminal and a service that the user has received through the terminal.

16. The method of claim 14, wherein the connection information comprises a port number of a protocol corresponding to an application layer of the terminal and a service in which the user has received through the terminal.

17. The method of claim 14, wherein the connection information comprises a port number of a protocol corresponding to an application layer, a signature corresponding to a payload, and a service that the user has received through the terminal.

18. The method of claim 14, wherein the searching for whether previous connection information exists further comprises detecting supportable layer information.
